(19) United States
(12) Patent Application Publication
(10) Pub. No.: US 2013/0065470 A1
(43) Pub. Date: Mar. 14, 2013

(54) Flame Resistant Fiber Blends and Flame Resistant Yarns, Fabrics, and Garments Formed Thereof

(71) Applicants: Moshe Rock, Brookline, MA (US); Michael Batson, Windham, NH (US); Heidi Carlone, Hooksett, NH (US); Shawn Flavin, Sandown, NH (US)

(72) Inventors: Moshe Rock, Brookline, MA (US); Michael Batson, Windham, NH (US); Heidi Carlone, Hooksett, NH (US); Shawn Flavin, Sandown, NH (US)

(73) Assignee: MMI-IPCO, LLC

(21) Appl. No.: 13/571,929

(22) Filed: Aug. 10, 2012

Related U.S. Application Data
(63) Continuation-in-part of application No. PCT/US2011/056577, filed on Oct. 17, 2011.
Application No. PCT/US2011/056577 is a continuation-in-part of application No. 13/045,799, filed on Mar. 11, 2011.
(60) Provisional application No. 61/451,352, filed on Mar. 10, 2011.

(51) Int. Cl. C08L 1/00; D03D 15/12; C08L 33/20; A41D 13/00; C08L 77/00; B32B 5/02; D04B 1/14

(52) U.S. Cl. 442/302; 428/221; 442/304; 2/455; 524/35

(57) ABSTRACT

A flame resistant fiber blend includes a plurality of modacrylic flame resistant fibers comprising a first weight percentage of the fiber blend; a plurality of non-flame resistant hydrophilic/absorbent fibers comprising a second weight percentage of the fiber blend, wherein the second weight percentage is greater than the first weight percentage; and a plurality of second flame resistant fibers comprising a third weight percentage of the fiber blend. In one implementation, the fiber blend includes 20 wt % to 45 wt % of modacrylic flame resistant fibers; 40 wt % to 75 wt % of hydrophilic/absorbent fibers; and 5 wt % to 30 wt % of second flame resistant fibers. The flame resistant fiber blend is used to form flame resistant yarns, fabrics, and garments formed thereof.

This application claims priority from International Application No. PCT/US2011/056577, filed Oct. 17, 2011, now pending, which claims priority from U.S. patent application Ser. No. 13/045,799, filed Mar. 11, 2011, now pending, and U.S. Provisional Application No. 61/451,352, filed Mar. 10, 2011, now expired. U.S. patent application Ser. No. 13/045,799 claims priority from U.S. Provisional Application No. 61/326,369, filed Apr. 21, 2010, now expired. The entire disclosures of all of these applications are incorporated herein by reference.

### TECHNICAL FIELD

This disclosure relates to flame resistant fiber blends, and to flame resistant yarns, flame resistant fabrics, and flame resistant garments and apparel formed of such flame resistant fiber blends, including safety garments and apparel.

### BACKGROUND

Individuals working in environments where there is a risk of flash fire need to wear flame resistant protective apparel. Example occupations include, but are not limited to, petrochemical and gas workers, industrial workers, and fire service personnel who seek to wear flame resistant apparel underneath their turnout gear or as a stand-alone garment for use in applications outside structural firefighting.

Individuals working near energized electrical equipment are exposed to potential risk from electric arc flash hazards that can occur from an arc flash event. Electrical arcs are formed in air when potential difference (i.e., voltage) between two electrodes causes atoms in the air to ionize and become able to conduct electricity.

### SUMMARY

In general, this disclosure relates to flame resistant fiber blends, and to flame resistant yarns and flame resistant fabrics formed of such flame resistant fiber blends, and to flame resistant garments and apparel, e.g. safety apparel and garments formed thereof.

In one aspect of the disclosure, a flame resistant fiber blend comprises: a plurality of modacrylic flame resistant fibers comprising a first weight percentage of the fiber blend; a plurality of non-flame resistant hydrophilic/absorbent fibers comprising a second percentage of the fiber blend, wherein the second weight percentage is greater than the first percentage; and a plurality of second flame resistant fibers comprising a third weight percentage of the fiber blend.

Preferred implementations of this aspect of the disclosure may include one or more of the following additional features. The flame resistant fiber blend comprises: 20 wt % to 45 wt % of modacrylic flame resistant fibers; 40 wt % to 75 wt % of non-flame resistant hydrophilic/absorbent fibers; and 5 wt % to 30 wt % of second flame resistant fibers. The non-flame resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof. The second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. The second flame resistant fibers comprise p-aramid fibers. The first weight percentage is between about 20 wt % and about 45 wt %, and the second weight percentage is between about 40 wt % and about 75 wt %. The third percent is between about 5% and about 30%.

In another aspect of the disclosure, a flame resistant yarn, e.g. for use in flame resistant fabric, e.g. knit or woven fabric, including for use in apparel, comprises: a plurality of modacrylic flame resistant fibers comprising a first weight percentage of the yarn; a plurality of non-flame resistant hydrophilic/absorbent fibers comprising a second percentage of the yarn, wherein the second weight percentage is greater than the first percentage; and a plurality of second flame resistant fibers comprising a third weight percentage of the yarn.

Preferred implementations of this aspect of the disclosure may include one or more of the following additional features. The flame resistant yarn comprises: 20 wt % to 45 wt % of modacrylic fibers; 40 wt % to 75 wt % of hydrophilic/absorbent fibers; and 5 wt % to 30 wt % of second flame resistant fibers. The non-flame-resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof. The second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. The flame resistant yarn is incorporate in a woven fabric, a knit fabric, a laminate fabric, or combinations thereof. The flame resistant yarn is incorporated in a fabric garment.

In still another aspect of the disclosure, flame resistant fabric, e.g. knit or woven fabric, including for use in apparel, comprises: a plurality of modacrylic flame resistant fibers comprising a first weight percentage of the fabric; a plurality of non-flame resistant hydrophilic/absorbent fibers comprising a second percentage of the fabric, wherein the second weight percentage is greater than the first percentage; and a plurality of second flame resistant fibers comprising a third weight percentage of the fabric.

Preferred implementations of this aspect of the disclosure may include one or more of the following additional features. The flame resistant fabric comprises: 20 wt % to 45 wt % of modacrylic flame resistant fibers; 40 wt % to 75 wt % of hydrophilic/absorbent fibers; and 5 wt % to 30 wt % of second flame resistant fibers. The non-flame-resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof. The second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. The fabric has a char length according to ASTM D6413 of less than 4 inches. The flame resistant fabric stops burning within no more than 2 seconds after removal of an external flame source according to ASTM D6413. The flame resistant fabric has an average arc resistance rating according to ASTM F1959 of at least 4 calories per tested sample. The flame resistant fabric has an average arc resistance rating according to ASTM F1959 of at least 1.0 calorie per fabric ounce per square yard. The flame resistant fabric has a heat and thermal shrinkage resistance according to ISO 17493 of less than about 10% shrinkage in both the length and width directions. The flame resistant fabric is a woven fabric, a knit fabric, a laminate fabric, or combinations thereof. The flame resistant fabric is incorporated in a fabric garment. The flame resistant fabric complies with the requirements of NFPA 2112 (2012 Ed.). The flame resistant fabric complies with the requirements of NFPA 1977 (2011 Ed.).

In another aspect of the disclosure, a flame resistant composite fabric comprises: a first flame resistant fabric layer; a second flame resistant fabric layer; and a barrier layer bonding together the first flame resistant fabric layer and the second flame resistant fabric layer, wherein at least one of the first flame resistant fabric layer and the second flame resistant fabric layer is formed of a fiber blend comprising: a plurality of modacrylic flame resistant fibers comprising a first weight percentage of the fiber blend, a plurality of non-flame resistant hydrophilic/absorbent fibers comprising a second weight percentage of the fiber blend, wherein the second weight percentage is greater than the first weight percentage; and a plurality of second flame resistant fibers comprising a third weight percentage of the fiber blend; and the composite layer is capable of withstanding temperature of 500° F. for at least 5 minutes without substantial change in the dimensional integrity of the flame resistant composite fabric.

Preferred implementations of this aspect of the disclosure may include one or more of the following additional features. At least one of the first flame resistant fabric layer and the second flame resistant fabric layer is formed of a fiber blend comprises: 20 wt % to 45 wt % of modacrylic flame resistant fibers; 40 wt % to 75 wt % of hydrophilic/absorbent fibers; and 5 wt % to 30 wt % of second flame resistant fibers. The non-flame-resistant hydrophilic/absorbent fibers are selected from among: cellulosic fibers, cotton fibers, regenerated cellulosic fibers, rayon fibers, Tencel® regenerated cellulosic fibers, lyocell regenerated cellulosic fibers, wool fibers, viscose fibers, modal fibers, and combinations thereof. The second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. The second flame resistant fibers comprise p-aramid fibers. The first weight percentage is between about 20 wt % and about 45 wt %, and the second weight percentage is between about 40 wt % and about 75 wt %. The third weight percent is between about 5 wt % and about 30 wt %. The flame resistant composite fabric may be incorporated in a fabric garment. The second (outer) flame resistant fabric layer is a woven layer, knit layer, laminate layer, or combinations thereof.

In another aspect of the disclosure, a flame resistant composite fabric comprises: a first flame resistant fabric layer; a second flame resistant fabric layer; and a barrier layer bonding together the first flame resistant fabric layer and the second flame resistant fabric layer, wherein at least one of the first flame resistant fabric layer and the second flame resistant fabric layer is formed of a fiber blend comprising: a plurality of modacrylic fibers comprising a first weight percentage of the fiber blend, a plurality of non-flame resistant hydrophilic/absorbent fibers comprising a second weight percentage of the fiber blend, wherein the second weight percentage is greater than the first weight percentage; and a plurality of second flame resistant fibers comprising a third weight percentage of the fiber blend; and wherein the flame resistant composite fabric offers protection from electric arc flash hazards and/or from flash fire hazards in accordance with one or more of the following Nation Fire Protection Association standards: NFPA 70E (2012 Ed.), NFPA 1975 (2009 Ed.), NFPA 1977 (2011 Ed.), NFPA 1951 (2007 Ed.), and NFPA 2112 (2012 Ed.).

Preferred implementations of this aspect of the disclosure may include one or more of the following additional features. At least one of the first flame resistant fabric layer and the second flame resistant fabric layer is formed of a fiber blend comprising: 20 wt % to 45 wt % of modacrylic fibers; 40 wt % to 75 wt % of hydrophilic/absorbent fibers; and 5 wt % to 30 wt % of second flame resistant fibers. The non-flame-resistant hydrophilic/absorbent fibers are selected from among: cellulosic fibers, cotton fibers, regenerated cellulosic fibers, rayon fibers, Tencel® regenerated cellulosic fibers, lyocell regenerated cellulosic fibers, wool fibers, viscose fibers, modal fibers, and combinations thereof. The second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. The second flame resistant fibers comprise p-aramid fibers. The first weight percentage is between about 20 wt % and about 45 wt %, and the second weight percentage is between about 40 wt % and about 75 wt %. The third weight percent is between about 5 wt % and about 30 wt %. The flame resistant composite fabric may be incorporated in a fabric garment. The second flame resistant fabric layer is a woven layer, a knit layer, a laminate layer, or combinations thereof. The flame resistant composite fabric may be incorporated in a fabric garment.

In still another aspect of the disclosure, a flame resistant garment comprises: a plurality of modacrylic flame resistant fibers comprising a first weight percentage of the garment; a plurality of non-flame resistant hydrophilic/absorbent fibers comprising a second percentage of the garment, wherein the second weight percentage is greater than the first percentage; and a plurality of second flame resistant fibers comprising a third weight percentage of the garment.

Preferred implementations of this aspect of the disclosure may include one or more of the following additional features. The flame resistant garment comprises: 20 wt % to 45 wt % of modacrylic flame resistant fibers; 40 wt % to 75 wt % of hydrophilic/absorbent fibers; and 5 wt % to 30 wt % of second flame resistant fibers. The non-flame-resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof. The second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof.

Implementations of the disclosure can provide one or more of the following advantages.

The flame resistant fabrics, e.g. knit or woven fabrics, and including composite fabrics, of the disclosure offer protection against electric arc and/or flash fire hazards.

The flame resistant fabrics of the disclosure have a laminated membrane-film-adhesive structure stabilized by a high level of cross-linking, to reduce thermal shrinking (at 500° F. for 5 minutes).

Alternatively, or in addition, the first and/or second flame resistant fabric layer is a knit or woven fabric where the fiber component(s) will have low shrinkage, e.g. less than about 10% shrinkage in both fabric directions, when exposed to heat (at 500° F. for 5 minutes). Fibers of a few materials such as p-aramid and m-aramid meet this requirement. It will be preferred to use these fibers, or fiber blends, in the stitch yarns of knit fabrics (which controls the dimensional stability when exposed to high heat) or in woven fabrics (warp and fill).

The raised surface of the knit construction (velour, grid, or box pattern) will be made of the same flame resistant fiber blend as the stitch or other flame resistant yarn, e.g. modacrylic fibers, non-flame resistant cellulosic fibers, e.g. cotton fibers, regenerated cellulosic fibers, rayon fibers, etc., and p-aramid fibers, and blends of same, in yarn and fabrics.

Implementations of the disclosure may also provide one or more of the following advantages. A flame resistant fiber blend is provided for use in flame resistant fabrics and flame resistant garments and apparel. The flame resistant fiber blend contains an intimate mixture of modacrylic flame resistant fibers; non-flame-resistant hydrophilic/absorbent fibers, e.g. cellulosic fibers, cotton fibers, regenerated cellulosic fibers, rayon fibers, Tencel® regenerated cellulose fibers, lyocell regenerated cellulosic fibers, wool fibers, and combinations thereof and second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. The amount or weight percentage of each component in the fiber blend is selected to provide the fiber blend with desired properties. For example, the fiber blend is flame resistant and has a high limited oxygen index (LOI). Yarns made from the fiber blend can be used as stitch yarn and/or as loop yarn incorporated in fabrics or garments described in U.S. Pat. No. 6,927,182, the entire disclosure of which is incorporated herein by reference. Fabrics made from the fiber blend can have good integrity when exposed to flame. The fabrics can also endure heavy wearing, e.g., rough abrasion under a military and/or paramilitary body armor, while providing a soft touch to human skin. In addition, the fiber blend can manage water effectively, e.g., by absorbing liquids, such as sweat, from human skin to provide additional comfort or temperature adjustment to the wearer. Selection of the materials also makes the fiber blend cost effective.

Implementations of fiber blends, yarns, and fabrics of the disclosure, at different levels of flame resistant properties, will include relatively higher weight percentage of hydrophilic/absorbent fibers like cellulosic fibers, cotton fibers, regenerated cellulosic fibers, etc., e.g. as compared to the weight percentage of modacrylic fibers. Relatively higher cellulosic fiber content, i.e. higher than modacrylic, will enhance the comfort level of the user, especially during higher levels of physical activity, as well as in high humidity and/or warm ambient conditions. The modacrylic fibers, even at a percentage as low as 20 wt %, in combination with cellulosic fibers at up to 70 or 75 wt % of the fiber blend, will still have sufficiently high LOI, e.g. higher than 28, to be considered as inherent flame resistant (“FR”). In other implementations, the non-flame resistant hydrophilic/absorbent fibers may be replaced, in part or in whole, with flame resistant (FR) cellulosic fibers, e.g. such as Lenzing™ FR treated regenerated cellulosic fibers, or with wool fibers, which by their nature have LOI of 24 to 26.

Implementations of flame resistant fabrics formed of flame resistant fiber blends of this disclosure will have different textile constructions, including, but not limited to, woven, knit, including circular knit and warp knit, non-woven, and combinations thereof, such as in laminates with or without a breathable or other membrane.

Other aspects, features, and advantages of this disclosure are in the description, drawings, and claims.

### DESCRIPTION OF DRAWINGS

FIG. 1 is a front perspective view of a flame resistant composite fabric garment formed of a fiber blend of this disclosure, in this example, a zippered jacket.

FIG. 2 is an end section view of a flame resistant composite fabric.

FIG. 3 is a side section view illustrating formation of a flame resistant composite fabric of the disclosure.

FIG. 4 is a side section view illustrating formation of another implementation of the flame resistant composite fabric of the disclosure.

FIG. 5A is a side section view illustrating formation of yet another implementation of the flame resistant composite fabric of the disclosure.

FIG. 5B illustrates the effects of controlled stretching on the flame resistant composite fabric of FIG. 5A.

Like reference symbols in the various drawings indicate like elements.

### DETAILED DESCRIPTION

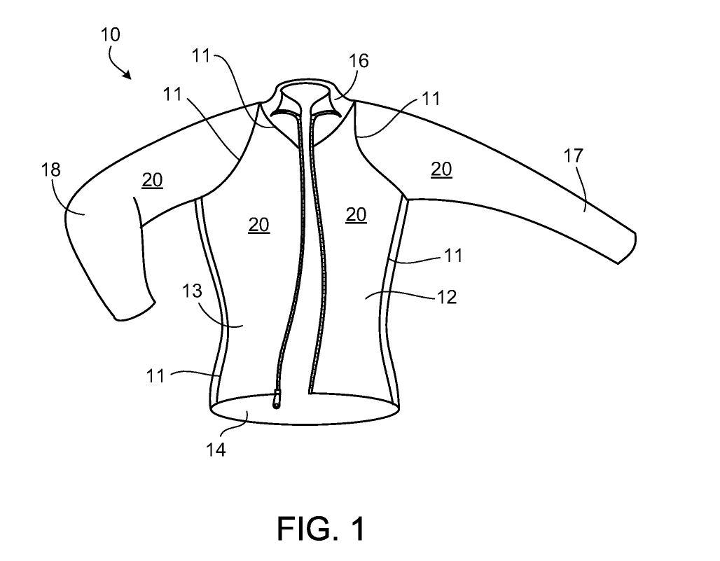

This disclosure relates to flame resistant fiber blends, and to flame resistant yarns, flame resistant fabrics, e.g. composite fabrics, and flame resistant apparel and other garments, e.g. safety apparel and other garments formed of such fiber blends. For example, a garment having the form of a zippered jacket garment 10 is shown in FIG. 1, but all manner of apparel and garments, including single layer knit or woven safety garments, and other fabrics and textile articles, are within the scope of this disclosure.

The flame resistant fiber blends can include a blend of modacrylic flame resistant fibers, available, e.g., from Kaneka Americas Holding, Inc., of Osaka, Japan (trademarks Protex®C and/or Protex®M) and from Formosa Chemicals & Fibre Corp., of Taipei, Taiwan; non-flame resistant hydrophilic/absorbent fibers, e.g. cellulosic fibers, cotton fibers, regenerated cellulosic fibers, rayon fibers, regenerated cellulose fibers (trademark Tencel®), lyocell regenerated cellulosic fibers, wool fibers, and combinations thereof; and second flame resistant fibers, e.g. para-aramid (p-aramid) fibers and meta-aramid (m-aramid) fibers, both available, e.g., from E.I DuPont de Nemours and Company, Inc., of Wilmington, Del. (trademarks (e.g., Kevlar® and Nomex®, respectively), polyamide-imide fibers (classified in the meta-aramid family), available, e.g., from SwicoFil AG, of Emmenbruecke, Switzerland (trademark Kermel®), polyarylate fibers, PBI (polybenzimidazole) fibers, melamine fibers, available, e.g. from Basofil Fibers, LLC, of Enka, N.C., USA (trademark Basofil®); FR rayon fibers, available, e.g., from Lenzing Aktiengesellschaft, of Lenzing, Austria (trademark Lenzing™), FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. Optionally, the fiber blend can also include functional fibers present in relatively small percentages, including, but not limited to: flame resistant and/or non-flame resistant antistatic fibers, e.g., to dissipate or minimize electrostatic build-up; stretch fibers; antimicrobial yarns or fibers, available from Noble Fiber Technologies, LLC, of Scranton, Pa. (trademark X-STATIC®); synthetic fibers with IR (infra-red) reflection or absorption; and/or other synthetic fibers. The flame resistant fiber blend can be made into flame resistant yarn, which in turn can be knitted or woven into flame resistant composite fabrics, e.g. for use in apparel. For example, the flame resistant composite fabrics are made into safety garments to provide arc protection and flame resistance.

The disclosure also relates to composite fabrics formed of the fiber blends, which include, e.g., a face fabric (an outer fabric layer) made from a flame resistant (or inherently flame resistant) woven or knit fabric that is permanently bonded with flame resistant chemistry (e.g., adhesive and additive) to an inner fabric (inner fabric layer) made from a flame resistant woven or knit fabric. The resulting composite meets the flame resistant testing requirements for wearer protection from electric arc flash. Through the selection of materials and processes, the resulting composite can also be adapted to provide a wide range of air permeability.

As used herein, “aramid” fibers refers to a polyamide wherein at least 85% of the amide (—COHN—) linkages are attached directly to two aromatic rings. Suitable aramid fibers are described in Man-Made Fibers-Science and Technology, Volume 2, section titled: “Fiber-Forming Aromatic Polyamides”, page 297, W. Black et al., Interscience Publishers, 1968, the entire disclosure of which is incorporated herein by reference. Aramid fibers are also described in U.S. Pat. Nos. 4,172,938; 3,869,429; 3,819,587; 3,673,143; 3,354,127; and 3,094,511, the entire disclosures of all of which are also incorporated herein by reference. P-aramids are those aramids having the amid linkages in the para-position relative to each other, while m-aramids are those aramids having amid linkages in the meta-position relative to each other.

As used herein, “non-flame resistant hydrophilic/absorbent” fibers is used to refer to cellulosic fibers, cotton fibers, regenerated cellulosic fibers, rayon fibers, wood pulp fibers, etc. Hydrophilic/absorbent fibers absorb moisture, and fabric formed of a combination of hydrophilic cellulosic fibers and modacrylic fibers can advantageously exhibit both wicking and moisture transport properties.

As used herein, “flame resistant treated cotton” and “flame resistant (FR) treated cotton blends” such as 88/12, as used herein, refer to cotton/nylon or 100% cotton containing fabrics that have been treated with flame resistant chemistry to impart flame resistance. These fabrics have in effect been “treated” to impart FR performance. The two common approaches to treating such fabrics are to bind phosphorus based chemistry to cellulose via use of an ammoniation chamber or via thermal treatment conducted on a thermosol finishing range. As used herein, a “thermosol finishing range” refers to a heated oven that employs dry heat at temperatures ranging from about 175° C. to 230° C. to perform thermosoling. “Thermosoling” as used herein is a process of chemically treating fabrics in which a chemical is diffused and fixed inside the fibers by means of dry heat.

As used herein, the term “flame resistant fabric” refers to a desired protective layer that has been woven, knitted or otherwise assembled using one or more different types of yarn that are either inherently flame resistant or are treated in fabric form to make them flame resistant. As used herein, the term “flame resistant composite fabric” refers to composite fabric created via bonding two or more layers of flame resistant fabric together without the use of sewing, stitch-bonding, quilting, or other processes that utilize a stitch or interlace yarn to combine two or more fabric layers.

The fiber blend can include, e.g., between about 20 wt % and about 45 wt % of modacrylic fibers. The modacrylic fibers are good flame resistant material, having a high resistance to chemicals and solvents, and a high LOI value, e.g. 32-34. In addition, modacrylic fibers are soft and flexible. These fibers can bend easily and have a relatively softer touch to human skin, e.g. as compared to p-aramid and m-aramid fibers. Modacrylic fibers are also an economical material. Use of modacrylic fibers in the fiber blend (or the yarn or the fabric) can provide the fiber blend with good flame resistance properties at a relatively low cost.

The modacrylic fibers used in the fiber blend can be Protex®C, Protex®M, or a combination of the two materials. Protex C is relatively finer (having a denier of about 1.7) than Protex®M (having a denier of about 2.2). The selection of Protex®C, Protex®M or their combination can be made based on the desired properties, e.g., being fine, of the yarn to be made from the fiber blend. In some embodiments, the modacrylic fibers used in the fiber blend can include about 10 wt % to about 90 wt % of Protex®C and about 90 wt % to about 10 wt % of Protex®M.

Suitable non-flame resistant natural fibers or regenerated fibers for use in the fiber blend can include cellulosic fibers, cotton fibers, wool fibers, rayon fibers, viscose fibers, modal fibers, rayon fibers, and others, e.g., lyocell or Tencel® regenerated cellulose fibers, e.g. available from Lenzing Aktiengesellschaft, of Lenzing, Austria. In some implementations, the fiber blend can include between about 40 wt % and/or up to about 75 wt % of non-flame resistant hydrophilic/absorbent fibers, selected e.g. from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof. Inclusion of these fibers can improve water management capability of the fiber blend without adversely affecting the flame resistance properties of the fiber blend. For example, the fiber blend can remove excessive liquid sweat from human skin, e.g., by wicking the liquid sweat and/or absorbing the liquid sweat from the skin. In some implementations, the natural or regenerated fibers are hydrophilic. The hydrophilicity of the natural fibers can further facilitate the ability of the fiber blend to manage water, e.g., sweat from human skin.

In some implementations, the fiber blend includes at least about 5% by weight (“wt %”), e.g., at least about 7 wt %, and/or up to about 25 wt %, or even up to 30 wt %, e.g., up to about 17 wt %, or 18 wt %, of second flame resistant fibers, e.g. selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof. For example, p-aramid fibers are a high strength material and can provide a yarn made out of the fiber blend with strength, e.g., tensile strength as well as abrasion resistant. In addition, the p-aramid fibers can provide fabric integrity when the fabric is exposed to flame. For example, the p-aramid fibers restrict (or inhibit) the fiber blend (in the yarn or in the fabrics) from carbonizing and disintegrating and keeps the fabric integral. Furthermore, the p-aramid fibers can provide toughness to the fabric for use in heavy wear or rough abrasion, e.g., rough abrasion under military or paramilitary body armor. In some implementations, the flame resistant composite fabric used at different portions of apparel has different percentages of the p-aramid fibers (or Kevlar®). For example, in a garment to be worn by military or para-military personnel, the garment portions where body armor is located or carried may include a higher percentage, e.g., 10 wt % to 15 wt % of the p-aramid fibers, than portions where no body armor is located or carried, which can include, e.g., 8 wt % to 12 wt % of the p-aramid fibers. In some implementations, multiple layers (e.g., knitted layers) of the fiber blend can be used, e.g., laminated, into the fabrics for use in a garment. As an example, the outermost layer can include a high percentage of the p-aramid fibers to protect the garment made from the laminated fabrics from rough abrasion.

In some implementations, the fiber blend comprises 20 wt % to 45 wt % of modacrylic flame resistant fibers; 40 wt % to 75 wt % of non-flame resistant hydrophilic/absorbent fibers; and 5 wt % to 30 wt % of second flame resistant fibers, as discussed above. Fiber blends having such components (and the yarns or fabric layers containing or made of the fiber blends) can have a low shrinkage, e.g. less than about 10% shrinkage in both fabric directions, when exposed to heat at 500° F. for 5 minutes and low flammability.

In some implementations, the fiber blend includes up to between about 5% and/or up to about 30 wt % of m-aramid fibers, e.g., Nomex®. The m-aramid fibers can provide good thermal, chemical, and radiation resistance, and have good flame resistant properties and low thermal shrinkage, e.g. less than about 10% shrinkage in both fabric directions, when exposed to heat (at a temperature of 500° F. for 5 minutes). For example, the m-aramid fibers, e.g., super flame resistant m-aramid fibers, have a high limiting oxygen index (LOI) of about 37 to about 44. Also, the m-aramid fibers are strong fibers and can provide the fabric made of the fiber blend with a reasonable abrasion resistance. The m-aramid fibers have good strength retention when exposed to heat, as well as good stress-strain property at temperatures above the melting points of other synthetic fibers.

In some implementations, the fiber blend forming at least one of the first flame resistant fabric layer and/or the second flame resistant fabric layer, e.g. both of the first and second flame resistant fabric layers, is formed of an intimate fiber blend comprising: a plurality of modacrylic fibers comprising a first weight-percentage (“wt %”) of the fiber blend; a plurality of non-flame resistant hydrophilic/absorbent fibers comprising a second weight-percentage of the fiber blend, wherein the second weight-percentage is greater than the first weight-percentage; and a plurality of second flame resistant fibers comprising a third weight-percentage of the fiber blend. The non-flame resistant hydrophilic/absorbent fibers are selected, e.g., from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof. The second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, and combinations thereof. The first weight-percentage is between about 20 wt % and about 45 wt %, and the second percentage is between about 40 wt % and about 75 wt %. The third weight-percent is between about 5 wt % and about 30 wt %.

The fiber blend can also include about 1 wt % to about 5 wt % of antistatic fibers to reduce or eliminate static electricity on the surface of the flame resistant composite fabrics. Suitable antistatic fibers can include carbon fibers or synthetic fibers containing carbon or silver. The antistatic fibers may be flame resistant or non-flame resistant, as desired. As discussed above, other functional fibers may also be present in relatively small percentages.

Examples of formulations of intimate fiber blends of the disclosure described above, i.e. comprising modacrylic fibers, non-flame resistant hydrophilic/absorbent cellulosic fibers, and second flame resistant fibers, include, without limitation:

Example A:

40 wt % modacrylic fibers

45 wt % cellulosic/rayon (non-flame resistant) fibers

15 wt % Kevlar® (p-aramid) fibers

Example B:

39 wt % modacrylic fibers

43 wt % cellulosic/rayon (non-flame resistant) fibers

18 wt % Kevlar® (p-aramid) fibers

Example C:

27 wt % modacrylic fibers

43 wt % cellulosic/rayon (non-flame resistant) fibers

18 wt % Kevlar® (p-aramid) fibers

Example D:

25 wt % modacrylic fibers

40 wt % cellulosic/rayon (non-flame resistant) fibers

15 wt % Kevlar® (p-aramid) fibers

20 wt % Basofil (melamine) fibers

Example E:

27 wt % modacrylic fibers*

55 wt % cellulosic/rayon (non-flame resistant) fibers

15 wt % Kevlar® (p-aramid) fibers *30% Protex® V Blend (90% modacrylic fibers with 10% polyarylate (aromatic polyethylene) fibers)

Example F:

29.4 wt % modacrylic fibers

50 wt % cellulosic/rayon (non-flame resistant) fibers

15 wt % Kevlar® (p-aramid) fibers** **35% Protex® V Blend (84% modacrylic fibers with 16% polyarylate (aromatic polyethylene) fibers)

The fiber blend described above can made into yarns using commonly known methods, such as yarn spinning techniques including ring spinning, core spinning, and air jet spinning, or higher air spinning techniques such as Murata air jet spinning. The yarn can be incorporated in a knit, e.g., circular knit or warp knit, or a woven construction. A circular knit construction can include, for example, single jersey or double knit. The yarn can also be incorporated in a plaited construction that includes terry sinker loop finished double face or single face, plain loop, or pillar terry loop. For example, the terry sinker loop is in a plaited construction or a reverse plated construction. In some implementations, the yarn is used in warp knitting, such as double needle bar knitting (Raschel knitting) or tricot (plain or mesh). In additional to being used as a stitch yarn, the yarn can also be used as a pile yarn (e.g., in a fleece, velour, or high pile). The yarn can be used in a raised surface and/or a stitch. The high pile yarn can be made using double needle bar knitting (Raschel knitting) or cut loop circular knit. For example, the loops of the loop circular knit can be cut on a knitting machine or after the knitting as part of the finishing process. Various knit constructions and woven constructions are described in U.S. Pat. No. 6,927,182, the entire disclosure of which is incorporated herein by reference. The yarn can be used in three-end fleece and in two-end fleece.

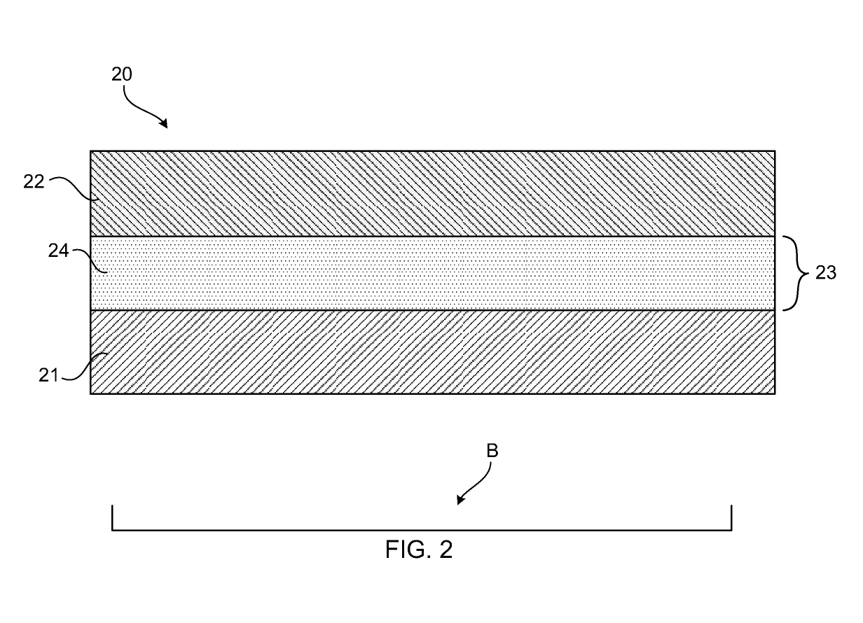

A flame resistant composite fabric made of the yarn can include one or more layers, e.g., laminated layers, of the knit or woven constructions. An example of such a flame resistant composite fabric can be the composite fabric 20 of FIG. 2 discussed below. Each laminated layer, and the composite fabric made of the laminated layers, can have a low thermal shrinkage, e.g. less than about 10% shrinkage in both fabric directions, when exposed to heat at a temperature of 500° F. for 5 minutes. For example, inclusion of the p-aramid or m-aramid in the fiber blend of the laminated layers can reduce the shrinkage of each layer. The laminated layers can have the same or different constructions. In the example of laminating two constructions, a woven construction can be laminated with another woven or a knit construction, or a knit construction can be laminated with another knit construction. In some implementations, a knit construction is tough and can withstand wear well, and a woven construction may be versatile. The lamination of different constructions can provide desired fabric properties. The knit construction in the laminated structure can have a plain surface or a patterned surface including raised portions. In some implementations, the patterned surface provides a desired surface contact with human skin. The various constructions or layers in a laminated structure or fabric can be bonded together, e.g., using an adhesive. In some implementations, the laminated structure or fabric can have a membrane, e.g., a breathable membrane or a water-proof membrane, between the laminated layers or on one or more surfaces of the laminated structure.

In some implementations, the flame resistant fiber blend can be rendered hydrophilic for use, e.g., in fabrics adjacent to human skin. A fiber blend is rendered hydrophilic when the fiber blend is made relatively less hydrophobic, e.g. during processing, as compared to the fiber blend before processing. In some implementations, a yarn made from the fiber blend or a fabric made from the yarn can be processed to be hydrophilic (or relatively less hydrophobic than before being processed). Suitable processing methods can include adding to the fiber blend, the yarn, or the fabric a material such as low molecular weight polyester. For example, the low molecular weight polyester can be added in a dye bath that is used to dye the yarn or the fabric. Suitable low molecular weight polyesters are described, e.g., in U.S. Pat. No. 5,312,667, the entire disclosure of which is incorporated herein by reference.

The fiber blend, yarn, or fabric that is rendered hydrophilic can be used as an inner fabric layer of a garment. As a result, transfer of perspiration from the surface of the inner fabric layer to an outer fabric layer is enhanced because liquid moisture can be transported along the surface fibers of the inner fabric by capillary action. In some implementations, the outer layer of the laminate can be made hydrophobic and/or oleophobic by reducing its surface energy, for example, by depositing particles on the surface of the outer layer to resemble a lotus effect.

FIG. 1 illustrates a flame resistant composite fabric garment 10 that offers the wearer protection from electric arc and flame hazards. The flame resistant composite fabric garment 10 (in this drawing, by way of example only, in the form of a zippered jacket) is constructed from a plurality of fabric elements that are joined together by stitching at seams 11. The fabric elements include left and right front elements 12, 13, a rear element 14, a collar element 16, and left and right arm elements 17, 18. Each of these fabric elements is formed of flame resistant (FR) composite fabric.

FIG. 2 illustrates a flame resistant composite fabric 20 suitable for forming the fabric elements. The flame resistant composite fabric 20 consists of a first (inner) fabric layer 21, which forms an inner surface of the fabric garment 10 (FIG. 1) worn towards a user's body, B; and a second (outer) flame resistant fabric layer 22, which forms an outer surface of the fabric garment 10. The first and second fabric layers 21, 22 can each contain or be formed of the fiber blend previously discussed. The first and second flame resistant fabric layers 21, 22 are permanently bonded together via a flame resistant (FR) barrier layer 23 that has a flame resistant chemistry that allows the resulting composite fabric 20 to meet the performance requirements of one or more of the following National Fire Protection Association (NFPA) standards: NFPA 70E (2012 Ed.), NFPA 1975 (2009 Ed.), NFPA 1977 (2011 Ed.), NFPA 1951 (2007 Ed.), and/or NFPA 2112 (2012 Ed.). The entire disclosure of each of the abovementioned National Fire Protection Association (NFPA) standards is incorporated herein by reference.

The flame resistant composite fabric has an air permeability of about 0 ft³/ft²/min to about 200 ft³/ft²/min, tested according to ASTM D-737 under a pressure difference of ½ inch of water across the flame resistant composite fabric. The entire disclosure of ASTM D-737 is incorporated herein by reference. The air permeability of the flame resistant composite fabric can be controlled via the selection of materials used for the first and second flame resistant fabric layers 21, 22, and the flame resistant barrier layer 23.

Referring to FIG. 2, the first flame resistant fabric layer 21 consists of flame resistant fabric. The first (inner) flame resistant fabric layer 21 can, for example, have a construction selected from among, e.g., woven construction having one-way stretch, with or without raised surface; woven construction having two-way stretch, with or without raised surface; knit construction (e.g., circular or warp knit) with or without raised surface (e.g., fleece (lofted) and jersey (flat) knits). The first (inner) flame resistant fabric layer 21 has a weight of about 3 ounces per square yard to about 12 ounces per square yard, and is formed of flame resistant modacrylic and p-aramid fibers in an intimate blend with non-flame-resistant hydrophilic/absorbent, cellulosic fibers, such as cellulosic fibers, including, without limitation, cotton fibers, regenerated cellulosic fibers, rayon fibers, Tencel® regenerated cellulosic fibers, and blends including of one or more thereof.

In some cases, the first (inner) flame resistant fabric layer 21 can define one or more raised inner surface regions, i.e. facing towards the wearer, in the form of a pattern, such as grid, box, etc., selected to generate a channeling effect, e.g. as described in U.S. Pat. No. 6,927,182, the entire disclosure of which is incorporated herein by reference.

Referring still to FIG. 2, the second (outer) flame resistant fabric layer 22 consists of a woven or knit (e.g., warp knit or circular knit) flame resistant fabric. Suitable woven fabrics for the second flame resistant fabric layer 22 can comprise flame resistant treated cotton fabric or cotton blends such as “88/12” cotton/nylon. Woven fabrics formed of 100% aramid, aramid blends, and other flame resistant fabrics may also be used. The second flame resistant fabric layer 22, which weighs about 3 ounces per square yard to about 12 ounces per square yard, is formed of yarns of an intimate blend of modacrylic fibers; non-flame resistant hydrophilic/absorbent fibers, e.g. cellulosic fibers, cotton fibers, regenerated cellulosic fibers, rayon fibers, wool fibers, viscose fibers, modal fibers, etc., and combinations thereof; and second flame resistant fibers, e.g. p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, and combinations thereof. The second (outer) flame resistant fabric layer 22 may have stretch in at least one direction, e.g., one-way stretch in the width (wale) direction or two-way stretch including stretch in both the width (wale) and the length (course) direction. Alternatively, the second flame resistant fabric layer 22 may be formed from a low stretch or no stretch fabric. The second flame resistant fabric layer 22 can have inherent wind breaking property. The air permeability can be reduced further when the second (outer) flame resistant fabric layer is combined with the barrier layer.

Other examples of suitable flame resistant fabrics that can be used as the first (inner) flame resistant fabric layer and/or the second flame resistant (outer) fabric layer are described in U.S. Pat. No. 6,828,003, issued Dec. 7, 2004, the entire disclosure of which is incorporated herein by reference. As mentioned above, the flame resistant barrier layer 23 is positioned between and permanently bonds the first and second flame resistant fabric layers 21, 22. The flame resistant barrier layer 23 includes an adhesive 24 capable of withstanding exposure to a temperature of 500° F. for 5 minutes without changing the integrity of the composite fabric 20 such as by delamination, separation, shrinking, cracking, etc., as described in the ISO 17493 “Clothing and equipment for protection against heat—Test method for convective heat resistance using a hot air circulating oven” test method requirements, the entire disclosure of which is incorporated herein by reference. Suitable adhesives may include adhesives with low shrinkage at high temperatures, cross-linked adhesives, thermosetting adhesives (1, 2, or 3 component). The adhesive 24 may, in one form, be applied by means of transfer coating from release paper at between 0.25 oz/yd² and 2.5 oz/yd². In another form, the adhesive may be applied by means of a solvent bath.

The adhesive 24 can be inherently flame resistant, such as a polyvinyl chloride (PVC) based adhesive. Alternatively, or in addition, the adhesive 24 can include one or more chemical additives selected from brominated aromatic chemical (e.g., decabromodiphenyl oxide (DBDPO), penta bromo phenyl, etc.), antimony trioxide, and blends thereof, which result in the creation of a flame resistant composite fabric suitable for protection from electric arc and flash fire hazards. In some embodiments, for example, the flame resistant barrier layer 23 includes a polyurethane-based adhesive with an additive system that consists of a blend of DBDPO and antimony trioxide.

Alternatively, or in addition, the adhesive 24 can include a base polymer (e.g., acrylic, polyurethane, etc.) and a cross-linking agent, such as melamine. A relatively high level of cross-linking agent will turn the thermoplastic polymer binder/adhesive to a very stable chemical that may resemble thermosetting polymer.

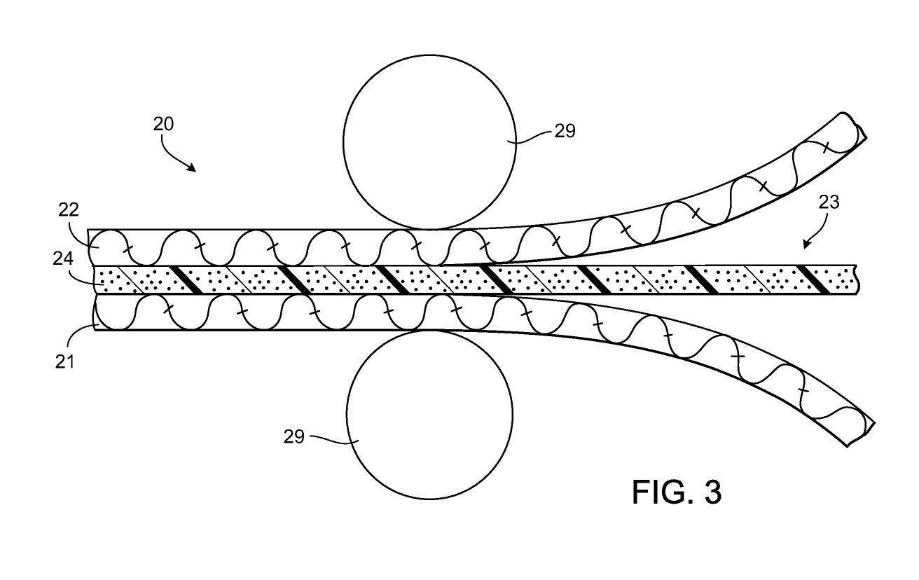

Air permeability can be provided and controlled by applying the adhesive 24 as a continuous layer, and then mechanically modifying the layer of adhesive such as by crushing or stretching. For example, referring to FIG. 3, air permeability can be controlled by applying the adhesive on the fabric and then using some type of mechanical processing, such as treatment with rollers 19, in order to create the desired levels of air permeability.

Still referring to FIG. 3, adhesive 24 may be applied by means of a release paper, wherein the adhesive is first placed on release paper at between about 0.25 oz/yd² and 2.5 oz/yd², after which one of the fabric layers is placed on top of the adhesive in order for bonding to occur between an opposed first surface of the adhesive layer and the fabric layer. The release paper is then stripped from the fabric and the second flame resistant fabric layer is applied to the surface of the adhesive. The composite then undergoes mechanical processing through opposed rollers 29 (which may be heated to a temperature of between about 100° F. and 375° F.), which apply pressure to the composite fabric. As can be appreciated, by changing any mechanical parameter (roller temperature, pressure applied, and speed of the fabric through the rollers), the air permeability characteristics of the composite fabric can also be modified.

Alternatively, and still referring to FIG. 3, adhesive 24 may be applied directly to one of fabric layers 21 and 22 (at 0.25 oz./yd.² to 2.5 oz./yd.²) without the use of release paper. As before, the composite fabric will undergo mechanical processing in order to achieve desired air permeability performance.

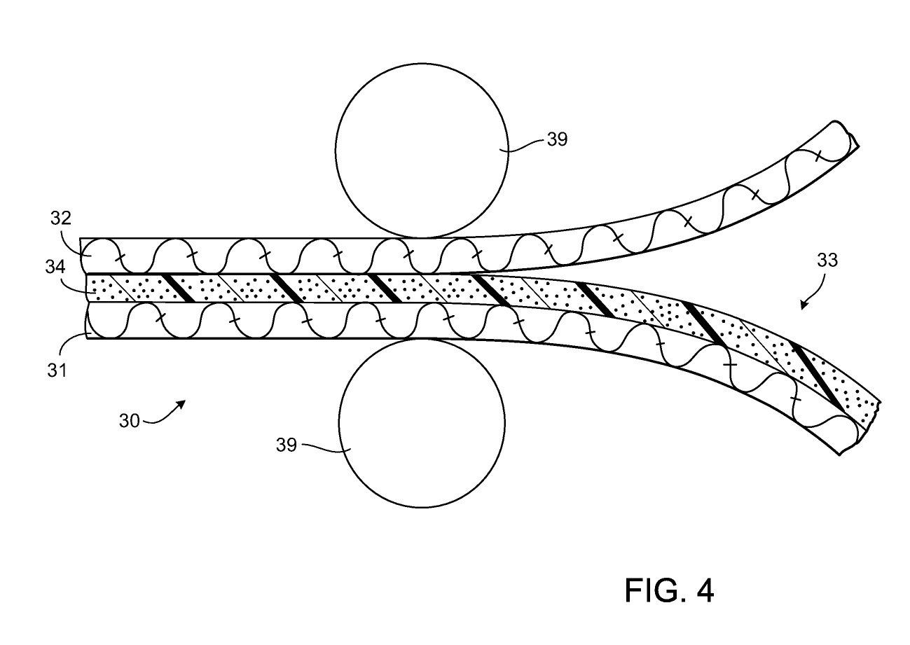

Alternatively, foamed adhesive can be used to provide air permeability. Referring now to FIG. 4, another implementation of the inventive flame resistant composite fabric is shown and generally indicated at 30. The flame resistant composite fabric 30 includes first and second flame resistant fabric layers 31 and 32, and a barrier layer 33 consisting of an intermediate adhesive 34. The barrier layer 33 is capable of withstanding exposure to a temperature of 500° F. for 5 minutes without changing the integrity of the composite fabric 20, such as by delamination, separation, shrinking, cracking, etc. The first and second flame resistant fabric layers 31 and 32 both have flame resistant woven or knit construction, such as described above with reference to FIG. 2.

The adhesive 34 can be inherently flame resistant, such as a polyvinyl chloride (PVC) based adhesive. Alternatively, or in additional, the adhesive 34 can include one or more chemical additives selected from brominated aromatic chemical (e.g., decabromodiphenyl oxide (DBDPO), penta bromo phenyl, etc.), antimony trioxide, and blends thereof, which result in the creation of a flame resistant composite fabric suitable for protection from electric arc and flash fire hazards. In some embodiments, for example, the barrier layer 33 consists of a polyurethane-based adhesive that includes flame resistant additives that consist of a blend of DBDPO and antimony trioxide.

Alternatively, or in additional, the adhesive 34 can include a base polymer (e.g., acrylic, polyurethane, etc.) and a cross-linking agent, such as melamine.

The chemical makeup of the adhesive 34 can help to provide a flame resistant composite fabric that is suitable for protection from electric arc and/or flash fire hazards in accordance with one or more of the following National Fire Protection Association (NFPA) standards: NFPA 70E (2009 Ed.), NFPA 1975 (2009 Ed.), NFPA 1977 (2011 Ed.), NFPA 1951 (2007 Ed.), and/or NFPA 2112 (2012 Ed.). Here, the adhesive 34 is applied as foam at between about 0.3 oz/yd² and 10 oz/yd². The foam density (mixing air with adhesive) and the amount of adhesive applied are selected depending on the desired air permeability of the flame resistant composite fabric 30. The flame resistant composite fabric 30 is prepared by first applying foam adhesive 34 on one of the opposed surfaces of fabric layers 31 and 32. Once the adhesive is applied, the other fabric layer is placed upon the adhesive in order to produce the flame resistant fabric composite of the disclosure. The flame resistant composite fabric 30 is then mechanically processed by means of a pair of rollers 39, which apply pressure thereto in an amount between about 10 lbs./in.² and 150 lbs./in.² in order to produce a composite having a specific level of air permeability.

Air permeability can also be provided by applying the adhesive, e.g., via rotary printing and/or gravure rolling, in a discontinuous pattern, such as in a dot coating pattern.

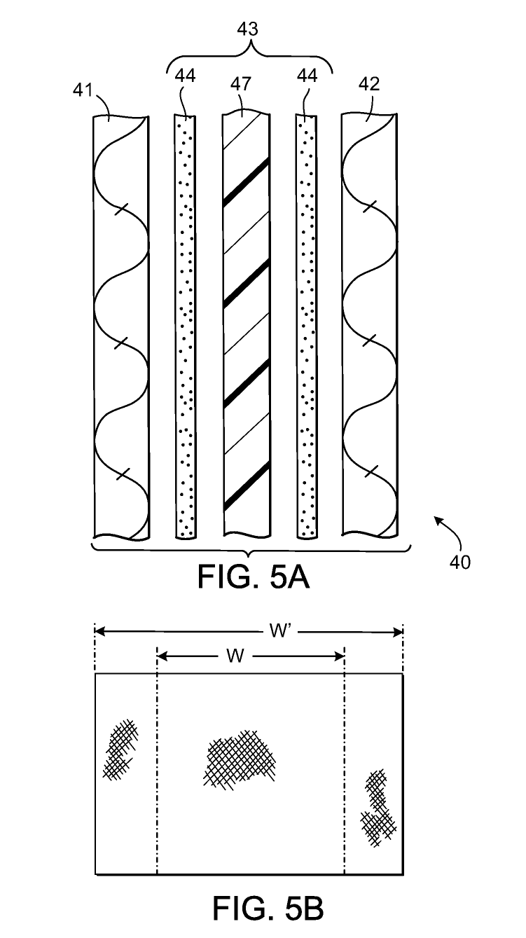

FIG. 5A illustrates yet another implementation of the inventive flame resistant composite fabric of this disclosure, which is generally indicated at 40. The flame resistant composite fabric 40 includes first and second flame resistant fabric layers 41 and 42, both of which have a flame resistant woven or knit construction such as described above with reference to FIG. 2. The flame resistant composite fabric 40 also includes a barrier layer 43 capable of withstanding exposure to a temperature of 500° F. for 5 minutes without changing the integrity of the composite fabric 40 such as by delamination, buckling, etc. The FR barrier layer 43 may consist of a membrane layer 47 disposed between two adhesive layers 44 for adhering the membrane layer 47 between the first and second FR fabric layers 41, 42.

The adhesive layers 44 can be inherently flame resistant, such as a polyvinyl chloride (PVC) based adhesive. Alternatively, or in addition, the adhesive layers 44 can include one or more chemical additives selected from brominated aromatic chemical (e.g., decabromodiphenyl oxide (DBDPO), penta bromo phenyl, etc.), antimony trioxide, and blends thereof, which result in the creation of a flame resistant composite fabric suitable for protection from electric arc and flash fire hazards. In some embodiments, for example, the adhesive layers 44 consist of a polyurethane based adhesive that includes a flame resistant additive system that includes a blend of DBDPO and antimony trioxide.

Alternatively, or in addition, the adhesive layers 44 can include a base polymer (e.g., acrylic, polyurethane, etc.) and a cross-linking agent, such as melamine.

The adhesive layers 44 may be applied by means of transfer coating from release paper at a thickness of between 0.25 oz/yd² and 2.5 oz/yd². The membrane layer 47 can consist of: film, such as full film; breathable membrane; hydrophobic porous membrane; or non-porous hydrophilic membrane with very high water resistance. Examples of suitable membranes are described, e.g., in U.S. patent application Ser. No. 12/368,225, filed Feb. 9, 2009 (U.S. Patent Publication No. 2009-0197491, published Aug. 6, 2009), U.S. patent application Ser. No. 12/494,070, filed Jun. 29, 2009 (U.S. Patent Publication No. 2009-0260126, published Oct. 22, 2009), and U.S. patent application Ser. No. 11/001,893, filed Dec. 1, 2004 (U.S. Patent Publication No. 2005-0097652, published May 12, 2005), the entire disclosure of each of which is incorporated herein by reference. The membrane layer 47 may be applied by means of transfer coating from release paper at a thickness of between 0.0001 in. and 0.010 in., or directly on the fabric surfaces at a thickness of between 0.0003 in. and 0.010 in.

As shown in FIG. 5B, the composite fabric 40 having a width, W, is subjected to controlled stretching to produce a composite having a width, W′, with a desired predetermined level of air permeability.

The membrane layer 47 can also be made of electrospun membrane with good water resistance and controlled air permeability. The air permeability can be controlled via the fineness of the electrospun fibers, which may be about 100 nm to about 1,000 nm in diameter. The electrospun membrane can have a weight of about 2 g/m² to about 15 g/m². Examples of suitable electrospun membranes are described in U.S. patent application Ser. No. 12/354,986, filed Jan. 16, 2009 (U.S. Patent Publication No. 2009-0186548, published Jul. 23, 2009), the entire disclosure of which is incorporated herein by reference.

The various layers can be bonded together as described using one or more of the adhesive application and bonding processes described in U.S. patent application Ser. No. 12/354,986, filed Jan. 16, 2009 (U.S. Patent Publication No. 2009-0186548, published Jul. 23, 2009) and U.S. patent application Ser. No. 12/368,225, filed Feb. 9, 2009 (U.S. Patent Publication No. 2009-0197491, published Aug. 6, 2009), the entire disclosure of each of which is incorporated herein by reference.

### Test Methods

Abrasion Test

The abrasion performance of fabrics is determined in accordance with ASTM D-3884 “Standard Guide for Abrasion Resistance of Textile Fabrics (Rotary Platform, Double Head Method).”

Arc Resistance Test

The arc resistance of the composite fabrics of the disclosure is determined in accordance with ASTM F-1959 “Standard Test Method for Determining the Arc Thermal Performance Value of Materials for Clothing,” the entire disclosure of which is incorporated herein by reference. The flame resistant fabric of the disclosure has an arc resistance rating according to ASTM F1959 of at least 4 calories per tested sample, e.g. at least 1.0 calorie per fabric ounce per square yard.

Grab Test

The grab resistance of fabrics is determined in accordance with ASTM D-5034 “Standard Test Method for Breaking Strength and Elongation of Fabrics (Grab Test).”

Limited Oxygen Index (LOI) Test

The limited oxygen index (LOI) of fabrics, determined in accordance with ASTM G-125-00 “Standard Test Method for Measuring Liquid and Solid Material Fire Limits in Gaseous Oxidants,” measures the minimum concentration of oxygen, expressed as a volume percent, in a mixture of oxygen and nitrogen that will just support flaming combustion of a material initially at room temperature under the conditions of ASTM D2863.

Tear Test

The tear resistance of fabrics is determined in accordance with ASTM D-5587-03 “Standard Test Method for Tearing of Fabrics by Trapezoid Procedure.”

Vertical Flame Test

The char length of the composite fabrics of the disclosure is determined in accordance with ASTM D-6413 “Standard Test Method for Flame Resistance of Textiles (Vertical Method),” the entire disclosure of which is incorporated herein by reference.

Thermal Protective Performance (TPP)

The thermal protection performance of fabrics is determined in accordance with NFPA 2112 (2012 Ed.) “Standard on Flame Resistant Garments for Protection of Industrial Personnel Against Flash Fire.” The fabrics or garments comply with NFPA 1977 (2011 Ed.) “Standard on Protective Clothing and Equipment for Wildland Fire Fighting.”

The term “thermal protective performance” (or “TPP”) relates to the ability of a fabric to provide continuous and reliable protection to a wearer's skin beneath a fabric when the fabric is exposed to a direct flame or radiant heat.

A 6-inch square fabric specimen is suspended horizontally in a holder over two Meker burners and a radiant panel. Weighted sensors placed on top of the fabric (contact) and 6 mm away (spaced) measure the amount of time required for heat penetrating through the fabric to reach a temperature necessary to cause a 2^{nd} degree burn. This time is multiplied by the exposure heat flux to yield a TPP rating. The resulting measurement corresponds to the amount of time that passes until the wearer suffers a 2^{nd} degree burn.

Thermal Shrinkage and Heat Resistance (ISO 17493)

The convective heat resistance of fabrics or garments is tested using a hot air circulating oven according to the conditions of ISO 17493. A 15 inch square specimen that has been washed three times is marked for length and width and suspended in an air-circulating oven at 500° F. for five minutes, and the degree of shrinkage is calculated. For determination of heat resistance, the fabric sample is examined for melting, dripping, separation, or ignition.

Instrumented Mannequin (ASTM F 1930)

The fabric specimen formed into a size 42 regular coverall garment with specific trim and pocketing configuration is placed on an instrumented mannequin dressed in cotton underwear. The mannequin is subjected to overall heat and flame exposure for three seconds. Sensors embedded in the mannequin predict whether a 2^{nd} or 3^{rd} degree burn will occur at that location and a percent body rating is calculated. This is a pass/fail test where the fabrics created via this invention pass the ASTM F 1930 standard test with less than 50% predicted body burn.

Fabric Features

The flame resistant composite fabrics made of the fiber blend described previously can have good flame resistant properties. For example, the fabrics can have a char length according to ASTM D6413 of less than 4 inches. The char length of the fabrics is measured in a fabric flammability test according to ASTM D6413, in which a fabric sample is suspended vertically above a fixed external flame placed at the lower edge of the fabric sample. The extent of fabric burning (or charring) measured from the edge of the lower fabric sample is the char length of the fabric sample. The fabrics can stop burning, e.g., self-extinguish, within no more than 2 seconds after removal of the external flame source according to ASTM D6413. The flame resistant fabric of the disclosure has an arc resistance rating of at least 4 calories per tested sample, e.g. at least 1.0 calories per fabric ounce per square yard, tested according to ASTM 1959. The heat and thermal shrinkage resistance of the fabrics tested according to ISO 17493 is less than about 10% shrinkage in both the length and width directions. The fabrics comply with the requirements of NFPA 2112 (2012 Ed.) for fabrics and/or the requirements of NFPA 1977 (2011 Ed.) for thermal fabrics.

Instrumented Mannequin (ASTM F 1930)

See above under “Test Methods.”

A number of implementations of the disclosure have been described. It will be understood, however, that various modifications may be made without departing from the spirit and scope of the disclosure. For example, the fibers, yarns, fabrics, and/or garments of the disclosure may be subjected to chemical treatments not interfering with the flame resistance properties. These may include: DWR treatment, for durable water repellency; fabric and/or garment surface treatment to create disparities, e.g. of appearance, between front and back surfaces; depositing polymeric material, e.g. epoxy, on a fabric or apparel surface, to create a hard or super-hard surface; and/or IR (infra-red treatment), e.g. NIR (near IR) up to FIR (far IR). Accordingly, other implementations are within the scope of the following claims.

What is claimed is:

1. A flame resistant fiber blend comprising:
a plurality of modacrylic flame resistant fibers comprising a first weight percentage of the fiber blend;
a plurality of non-flame resistant hydrophilic/absorbent fibers comprising a second percentage of the fiber blend, wherein the second weight percentage is greater than the first percentage; and
a plurality of second flame resistant fibers comprising a third weight percentage of the fiber blend.

2. The flame resistant fiber blend of claim 1 comprising:
20 wt % to 45 wt % of modacrylic flame resistant fibers;
40 wt % to 75 wt % of non-flame resistant hydrophilic/absorbent fibers; and
5 wt % to 30 wt % of second flame resistant fibers.

3. The flame resistant fiber blend of claim 1, wherein the non-flame resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof.

4. The flame resistant fiber blend of claim 1, wherein the second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof.

5. The flame resistant fiber blend of claim 4, wherein second flame resistant fibers comprise p-aramid fibers.

6. The flame resistant fiber blend of claim 1, wherein the first weight percentage is between about 20 wt % and about 45 wt %, and the second weight percentage is between about 40 wt % and about 75 wt %.

7. The flame resistant fiber blend of claim 1, wherein the third percent is between about 5% and about 30%.

8. A flame resistant yarn, the yarn comprising:
a plurality of modacrylic flame resistant fibers comprising a first weight percentage of the yarn;
a plurality of non-flame resistant hydrophilic/absorbent fibers comprising a second percentage of the yarn, wherein the second weight percentage is greater than the first percentage; and
a plurality of second flame resistant fibers comprising a third weight percentage of the yarn.

9. The flame resistant yarn of claim 8 comprising:
20 wt % to 45 wt % of modacrylic fibers;
40 wt % to 75 wt % of hydrophilic/absorbent fibers; and
5 wt % to 30 wt % of second flame resistant fibers.

10. The flame resistant yarn of claim 8, wherein the non-flame-resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof.

11. The flame resistant yarn of claim 8, wherein the second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof.

12. The flame resistant yarn of claim 8, incorporate in a woven fabric, a knit fabric, a laminate fabric, or combinations thereof.

13. The flame resistant yarn of claim 8, incorporated in a fabric garment.

14. A flame resistant fabric, the fabric comprising:
a plurality of modacrylic flame resistant fibers comprising a first weight percentage of the fabric;
a plurality of non-flame resistant hydrophilic/absorbent fibers comprising a second percentage of the fabric, wherein the second weight percentage is greater than the first percentage; and
a plurality of second flame resistant fibers comprising a third weight percentage of the fabric.

15. The flame resistant fabric of claim 14 comprising:
20 wt % to 45 wt % of modacrylic flame resistant fibers;
40 wt % to 75 wt % of hydrophilic/absorbent fibers; and
5 wt % to 30 wt % of second flame resistant fibers.

16. The flame resistant fabric of claim 14, wherein the non-flame-resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof.

17. The flame resistant fabric of claim 14, wherein the second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof.

18. The flame resistant fabric of claim 14, wherein the fabric has a char length according to ASTM D6413 of less than 4 inches.

19. The flame resistant fabric of claim 14, wherein said fabric stops burning within no more than 2 seconds after removal of an external flame source according to ASTM D6413.

20. The flame resistant fabric of claim 14, wherein the fabric has an average arc resistance rating according to ASTM F1959 of at least 4 calories per tested sample.

21. The flame resistant fabric of claim 14, wherein the fabric has an average arc resistance rating according to ASTM F1959 of at least 1.0 calorie per fabric ounce per square yard.

22. The flame resistant fabric of claim 14, wherein the fabric has a heat and thermal shrinkage resistance according to ISO 17493 of less than about 10% shrinkage in both the length and width directions.

23. The flame resistant fabric of claim 14, wherein the flame resistant fabric is a woven fabric, a knit fabric, a laminate fabric, or combinations thereof.

24. The flame resistant fabric of claim 14, incorporated in a fabric garment.

25. The flame resistant fabric of claim 14, wherein the fabric complies with the requirements of NFPA 2112 (2012 Ed.).

26. The flame resistant fabric of claim 14, wherein the fabric complies with the requirements of NFPA 1977 (2011 Ed.).

27. A flame resistant composite fabric comprising:
a first flame resistant fabric layer;
a second flame resistant fabric layer; and
a barrier layer bonding the first flame resistant fabric layer to the second flame resistant fabric layer,
wherein at least one of the first flame resistant fabric layer and the second flame resistant fabric layer is formed of a fiber blend comprising:
a plurality of modacrylic flame resistant fibers comprising a first weight percentage of the fiber blend,
a plurality of non-flame resistant hydrophilic/absorbent fibers comprising a second weight percentage of the fiber blend, wherein the second weight percentage is greater than the first weight percentage; and
a plurality of second flame resistant fibers comprising a third weight percentage of the fiber blend; and
the composite layer is capable of withstanding temperature of 500° F. for at least 5 minutes without substantial change in the dimensional integrity of the flame resistant composite fabric.

28. The flame resistant composite fabric of claim 27, wherein at least one of the first flame resistant fabric layer and the second flame resistant fabric layer is formed of a fiber blend comprising:
20 wt % to 45 wt % of modacrylic flame resistant fibers;
40 wt % to 75 wt % of hydrophilic/absorbent fibers; and
5 wt % to 30 wt % of second flame resistant fibers.

29. The flame resistant composite fabric of claim 27, wherein the non-flame-resistant hydrophilic/absorbent fibers are selected from among: cellulosic fibers, cotton fibers, regenerated cellulosic fibers, rayon fibers, Tencel® regenerated cellulosic fibers, lyocell regenerated cellulosic fibers, wool fibers, viscose fibers, modal fibers, and combinations thereof.

30. The flame resistant composite fabric of claim 27, wherein the second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof.

31. The flame resistant composite fabric of claim 30, wherein the second flame resistant fibers comprise p-aramid fibers.

32. The flame resistant composite fabric of claim 27, wherein the first weight percentage is between about 20 wt % and about 45 wt %, and the second weight percentage is between about 40 wt % and about 75 wt %.

33. The flame resistant composite fabric of claim 27, wherein the third weight percent is between about 5 wt % and about 30 wt %.

34. The flame resistant composite fabric of claim 27, incorporated in a fabric garment.

35. The flame resistant composite fabric of claim 27, wherein the second flame resistant fabric layer is an outer woven layer, knit layer, laminate layer, or combinations thereof.

36. A flame resistant composite fabric comprising:
a first flame resistant fabric layer;
a second flame resistant fabric layer; and
a barrier layer bonding the first flame resistant fabric layer to the second flame resistant fabric layer,
wherein at least one of the first flame resistant fabric layer and the second flame resistant fabric layer is formed of a fiber blend comprising:
a plurality of modacrylic fibers comprising a first weight percentage of the fiber blend,
a plurality of non-flame resistant hydrophilic/absorbent fibers comprising a second weight percentage of the fiber blend, wherein the second weight percentage is greater than the first weight percentage; and
a plurality of second flame resistant fibers comprising a third weight percentage of the fiber blend; and
wherein the flame resistant composite fabric offers protection from electric arc flash hazards and/or from flash fire hazards in accordance with one or more of the following Nation Fire Protection Association standards: NFPA 70E (2012 Ed.), NFPA 1975 (2009 Ed.), NFPA 1977 (2011 Ed.), NFPA 1951 (2007 Ed.), and NFPA 2112 (2012 Ed.).

37. The flame resistant composite fabric of claim 36, wherein at least one of the first flame resistant fabric layer and the second flame resistant fabric layer is formed of a fiber blend comprising:
20 wt % to 45 wt % of modacrylic fibers;
40 wt % to 75 wt % of hydrophilic/absorbent fibers; and
5 wt % to 30 wt % of second flame resistant fibers.

38. The flame resistant composite fabric of claim 36, wherein the non-flame-resistant hydrophilic/absorbent fibers are selected from among: cellulosic fibers, cotton fibers, regenerated cellulosic fibers, rayon fibers, Tencel® regenerated cellulosic fibers, fibers, lyocell regenerated cellulosic fibers, wool fibers, viscose fibers, modal fibers, and combinations thereof.

39. The flame resistant composite fabric of claim 36, wherein the second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof.

40. The flame resistant composite fabric of claim 39, wherein the second flame resistant fibers comprise p-aramid fibers.

41. The flame resistant composite fabric of claim 36, wherein the first weight percentage is between about 20 wt % and about 45 wt %, and the second weight percentage is between about 40 wt % and about 75 wt %.

42. The flame resistant composite fabric of claim 36, wherein the third weight percent is between about 5 wt % and about 30 wt %.

43. The flame resistant composite fabric of claim 36, wherein the second flame resistant fabric layer is a woven layer, a knit layer, a laminate layer, or combinations thereof.

44. The flame resistant composite fabric of claim 36, incorporated in a fabric garment.

45. A flame resistant garment comprising:
a plurality of modacrylic flame resistant fibers comprising a first weight percentage of the garment;
a plurality of non-flame resistant hydrophilic/absorbent fibers comprising a second percentage of the garment, wherein the second weight percentage is greater than the first percentage; and
a plurality of second flame resistant fibers comprising a third weight percentage of the garment.

46. The flame resistant garment of claim 45 comprising:
20 wt % to 45 wt % of modacrylic flame resistant fibers;
40 wt % to 75 wt % of hydrophilic/absorbent fibers; and
5 wt % to 30 wt % of second flame resistant fibers.

47. The flame resistant garment of claim 45, wherein the non-flame-resistant hydrophilic/absorbent fibers are selected from among: cellulosic fibers, cotton fibers, regenerated cellulosic fibers, rayon fibers, Tencel® regenerated cellulose fibers, lyocell regenerated cellulosic fibers, wool fibers, viscose fibers, modal fibers, and combinations thereof.

48. The flame resistant fiber blend of claim 45, wherein the second flame resistant fibers are selected from among p-aramid fibers, m-aramid fibers, polyamide-imide fibers, polyarylate fibers, PBI (polybenzimidazole) fibers, Basofil® melamine fibers, FR rayon fibers, FR cellulosic fibers, FR treated cotton fibers, FR regenerated cellulosic fibers, PBO (polybenzoxazole) fibers, carbon fibers, polychal fibers, cross-linked polyacrylate fibers, PTFE fibers, copolyimide fibers, PVC fibers, and combinations thereof.
